(19) United States
(12) Patent Application Publication
(10) Pub. No.: US 2006/0125716 A1
(43) Pub. Date: Jun. 15, 2006

(54) Light-emitting diode display with compartment

(76) Inventors: Lye Yee Wong, Penang (MY); Yi Feng Hwang, Perak (MY); Elizabeth Ching Ling Fung, Penang (MY)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/010,211

(22) Filed: Dec. 10, 2004

(51) Int. Cl. G09G 3/14; G09G 3/06

(52) U.S. Cl. 345/46; 345/44

(57) ABSTRACT

A display segment includes a carrier, a first light-emitting diode attached to the carrier, and a second light-emitting diode attached to the carrier. An intermediate reflector structure is disposed on the carrier between the first light-emitting diode and the second light-emitting diode. The intermediate reflector structure has a first intermediate reflector wall proximate to the first light-emitting diode and a second intermediate reflector wall proximate to the second light-emitting diode.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

Light-emitting devices, such as light-emitting diodes (“LEDs”) used in LED displays, are packaged to facilitate handling and incorporation into electrical devices. LED dice are generally attached to a carrier, such as a printed circuit board, leadframe, or a flexible circuit, and electrically coupled the carrier with wire bonds. In some instances, the die is electrically and mechanically attached to the carrier, such as by soldering, conductive epoxy, or eutectic die attach, and a single wire bond from the top of the die to a trace on the carrier completes the electrical connection between the carrier and the LED die.

A plastic housing with a cavity that confines and directs the light output from the LED dice is typically placed on the carrier, with a number of LEDs being inside the cavity. The plastic housing is commonly called a “reflector” because it has reflective areas that direct the light from the LEDs in a desired direction, i.e. away from the carrier and dice. The cavity is usually filled or partially filled with optical-grade epoxy resin. Each cavity is commonly called a “segment” of the display.

Multiple dice are placed within a single cavity when a physically larger segment is desired. For example, a segment of a display for a wrist watch may be relatively small, while a segment of a display for a microwave oven or other household appliance is typically larger. Adding additional LEDs to a segment increases the total amount of light output by the segment, which is desirable for making brighter, large-format displays.

However, when two, three, or more LED dice are placed within a single cavity, the light emitted by that segment is often not uniform. Brightness is highly concentrated in certain areas, and appears as uneven brightness through out the segment. An area of a segment of an LED display with greater brightness is called a “hot spot.” FIG. 1A is a cross section of a conventional display segment 100 with two LED dice 102, 104. The LED dice 102, 104 are mounted on a carrier 106, and the tops of the LED dice 102, 104 are electrically connected to wire traces (not shown) on the carrier 106 with wire bonds 108, 110. The LED dice 102, 104 sit within a cavity 111 formed by a reflector 112 that is made of plastic and has reflective surfaces 114, 116 around the perimeter of the cavity 111. The remainder of the cavity is filled with an encapsulant 118, such as optical epoxy, silicon other organic or inorganic material. Alternatively, the cavity is not filled with a solid material, but is left as an air gap.

FIG. 1B shows the relative light intensity across the cavity of the display segment of FIG. 1A according to a modeled simulation. Hot spots 120, 122 occur essentially where the LED dice are located. A region of relatively low intensity 124 occurs between the hot spots 120, 122. For some display applications, such hot spots are unacceptable.

FIG. 2A is a cross section of a display segment 130 with an additional LED die 132 in the cavity 111′, which was one approach that was tried to reduce the hot spot regions of FIG. 1B. FIG. 2B shows the relative light intensity across the cavity of the display segment of FIG. 2A. The extra LED die fills in the low intensity region and reduces the perceived appearance of hot spots in the segment, but increases electrical power requirements for the segment, heat sinking, and cost by adding the additional relatively expensive LED die and associated die attach and wire bond.

Another approach to reducing hot spots is to include a diffusant in the epoxy used to encapsulate the LED dice and bond wires. Diffusants are made up of small particles that internally reflect and scatter incident light rays. This diffuses the light from hot spots, resulting in a more uniform intensity across the cavity of the segment. However, significant loss and absorption of light by the diffusant particles results in less light exiting from the segment.

FIG. 3 is a cross section of a display segment 140 that illustrates how light rays, represented by arrows from the LED die 102, travel through diffusant-loaded encapsulant 118′. Some of the light rays, such as the light ray 142, have to travel a relatively long way before it exits the diffusant-loaded encapsulant 118′. This results in loss of light intensity from the display segment 140.

Another approach to reducing hot spots is to deepen the cavity so that beam spreading from the LED dice produces a more uniform intensity across the segment. However, deepening the cavity results in a bigger packaged display, more material costs for the reflector, and more material costs for the encapsulant. Additionally, a deeper cavity means that all light from the LED dice has to travel through more encapsulant than a similar, shallower, cavity. This results in more light being absorbed and/or backscattered, particularly if the encapsulant includes diffusant, and less light being provided by the display segment.

It is desirable to reduce the formation of hot spots in LED display segments having multiple LEDs, and is further desirable to provide display segments having improved brightness.

### BRIEF SUMMARY OF THE INVENTION

A display segment includes a carrier, a first light-emitting diode attached to the carrier, and a second light-emitting diode attached to the carrier. An intermediate reflector structure is disposed on the carrier between the first light-emitting diode and the second light-emitting diode. The intermediate reflector structure has a first intermediate reflector wall proximate to the first light-emitting diode and a second intermediate reflector wall proximate to the second light-emitting diode.

### BRIEF DESCRIPTION OF THE DRAWINGS

FIG. 1A is a cross section of a conventional display segment with two LED dice.

FIG. 1B shows the relative light intensity across the cavity of the display segment of FIG. 1A.

FIG. 2A is a cross section of a display segment with an additional LED die in the cavity.

FIG. 2B shows the relative light intensity across the cavity of the display segment of FIG. 2A.

FIG. 3 is a cross section of a display segment that illustrates how light rays travel through diffusant-loaded encapsulant.

FIG. 4A is a cross section of a display segment for use in an LED display according to an embodiment of the invention.

FIG. 4B shows the relative light intensity across the cavity of the display segment of FIG. 4A.

FIG. 4C is a cross section of the display segment of FIG. 4A showing paths of light rays from the LED die.

FIG. 5A is a plan view of a display segment according to an embodiment of the invention.

FIG. 5B is an isometric view of the display segment of FIG. 5A showing the common carrier.

FIG. 6 is a plan view of a display segment according to another embodiment of the invention.

FIGS. 7A-7H are cross sections of embodiments of intermediate reflector structures.

### DETAILED DESCRIPTION OF THE EMBODIMENTS

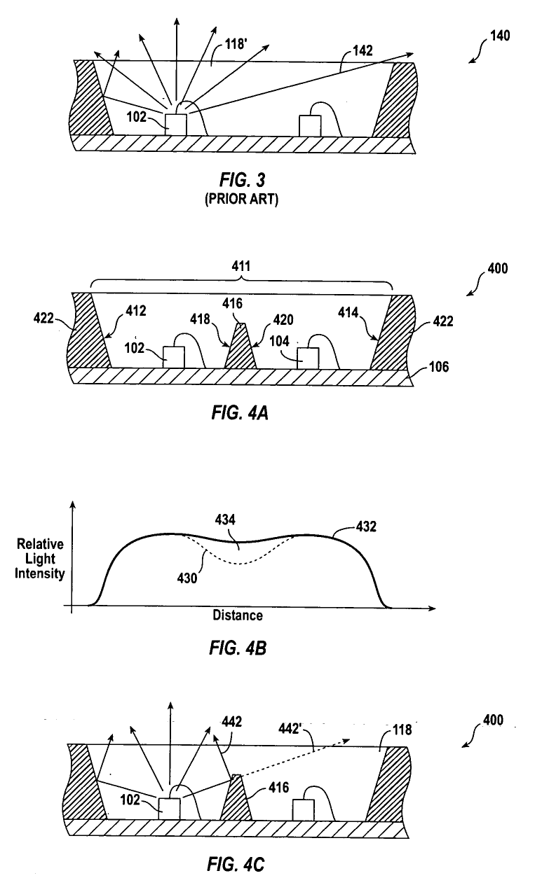

FIG. 4A is a cross section of a display segment 400 for use in an LED display according to an embodiment of the invention. The display segment 400 includes two LED diodes 102, 104, which in this embodiment are chips, also known as dice, mounted on a carrier 106. The carrier 106 is a ceramic base, printed circuit board, or a lead frame, for example. The LED dice 102, 104 sit within perimeter reflector walls 412, 414. An intermediate reflector structure 416 transects the cavity 411 between the LED dice 102, 104, forming two reflective compartments, one for each LED dice. The intermediate reflector structure 416 has intermediate reflector walls 418, 420 that cooperate with the perimeter reflector walls 412, 414, respectively, to increase to light output from the display segment 400 and to decrease hot spots (see FIG. 4C, below). The intermediate reflector walls 418, 420 are painted with a white light reflecting paint, such as paint having titanium oxide (TiO₂) pigment, to reflect those light rays less than the critical angle that otherwise might escape an unpainted wall. The paint layer is relatively thin, and does not appear separately in this view. The substrate is made of ceramic, printed-circuit board (“PCB”) material, or is a lead frame. In some embodiments, the reflectors are made of polycarbonate material. The reflector structure is coated or plated with aluminum, silver or nickel, for example, or is painted with a white or metallic paint. Alternatively, the material of the reflector is a reflective material, or is loaded with a reflective material, such as polycarbonate loaded with titanium oxide.

In some embodiments, the height of the intermediate reflector structure 416 (i.e. the maximum height as measured from the surface of the carrier that the LED dice are mounted on) is less than the height of the perimeter reflector walls. This provides better light uniformity from adjacent LED dice in certain applications. Having a lowered intermediate reflector structure also makes it less apparent to the end user, thus enhancing the cosmetic appearance of a display segment according to the invention when used with conventional display segments. Having a lowered intermediate reflector structure also allows filling the remainder of the cavity (i.e. that portion not occupied by the LED dice, intermediate reflector structure and wire bonds) with a single application of encapsulant.

In some embodiments, the intermediate reflector structure 416 is integrated with a reflector 422, which is made of plastic and then metalized or painted to form the reflective walls. In a particular embodiment the intermediate reflector structure and the perimeter reflector walls are injection-molded together. Alternatively, an intermediate reflector structure and a perimeter reflector are two components that are assembled on the carrier, which allows adding an intermediate reflector structure to conventional display cavities to result in a display segment with improved intensity and reduced hot spots.

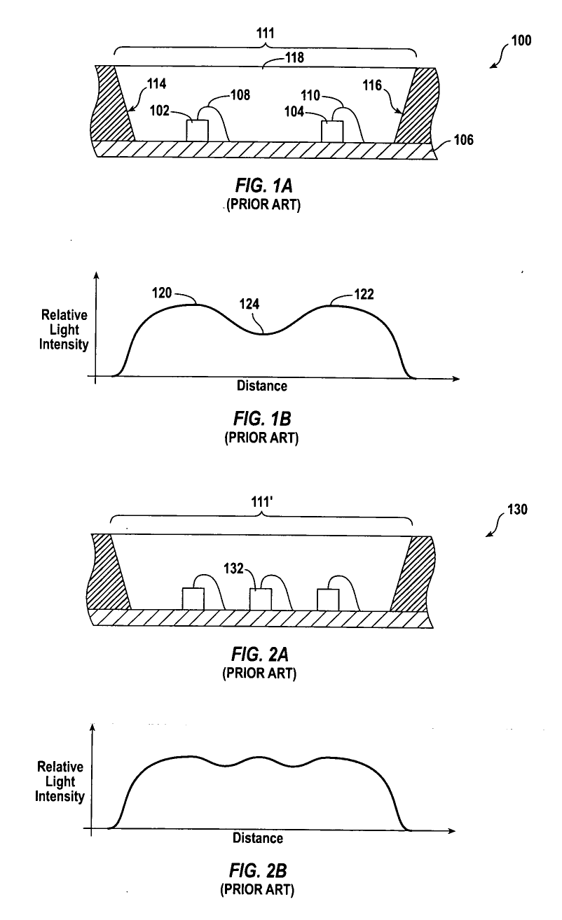

FIG. 4B shows the expected relative light intensity across the cavity 411 of the display segment 400 of FIG. 4A. The light intensity is substantially similar to that of FIG. 1B except for the region between the LED dice. The light intensity of the conventional display segment between the LEDs of the display segment of FIG. 1A is shown in a dashed line 430. The total light produced by the display segment 400 of FIG. 4A is the area under the intensity curve 432. Thus, the light from the display segment 400 of FIG. 4A is greater than the light from the conventional display segment 100 of FIG. 1A by the area 434 between the curves 430, 432. Similarly, the light intensity is more uniform between the LED dice of the embodiment of FIG. 4A, essentially eliminating the hot spots (see FIG. 1B, ref. nums. 120, 122) in the cavity of the segment.

FIG. 4C is a cross section of the display segment 400 of FIG. 4A showing paths of light rays, represented by arrows, from the LED die 102. The light ray 442 travels a much shorter path through the encapsulant 118 than a similar ray 442′ would travel if the intermediate reflector structure 416 were missing. A shorter path through the encapsulant 118 means that less light from the LED die 102 is absorbed and/or scattered. The angle and shape of the reflector structure are chosen according to the type of light source (e.g. LED) used, the cavity size, the placement of the die in the cavity, the encapsulant type, and the application of the display segment.

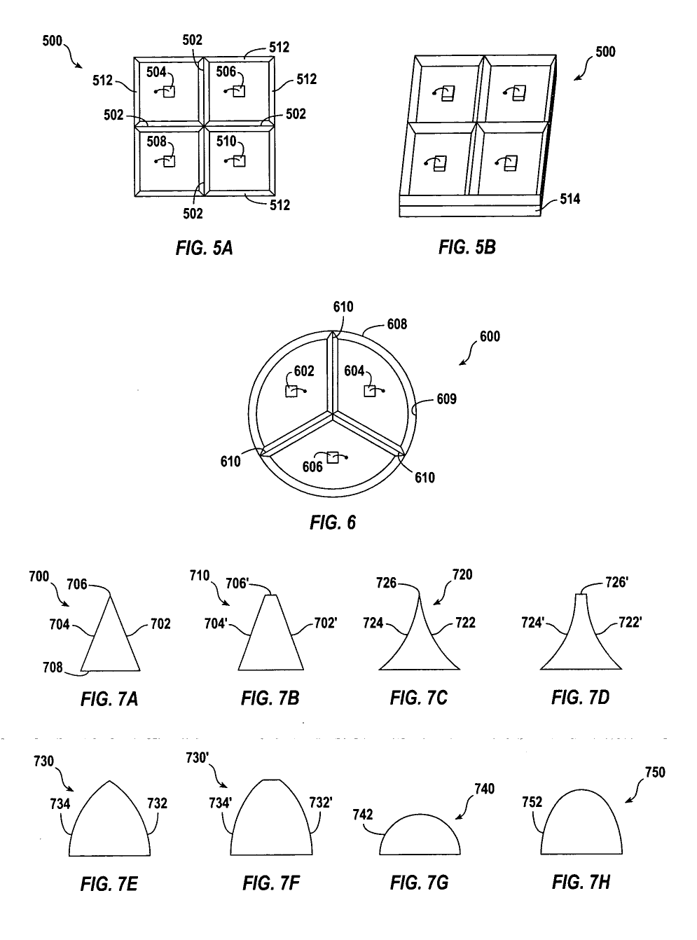

FIG. 5A is a plan view of a display segment 500 according to an embodiment of the invention. An intermediate reflector structure 502 extends between each of the LED diodes 504, 506, 508, 510, which are mounted on a common substrate (not shown in this view). The intermediate reflector structure is integrated with a perimeter reflector structure 512 to surround individual LEDs with reflective walls.

FIG. 5B is an isometric view of the display segment 500 of FIG. 5A showing the common carrier 514. In other words, each of the LED diodes in the display segment 500 is mounted on the same carrier 514. Electrical leads (not shown) extend from the bottom and/or sides of the carrier. In one embodiment, each LED is independently controllable to allow setting the light output of each LED to a desired level. Alternatively, two or more of the LEDs in a segment share an electrical connection. In a particular embodiment, all of the LEDs in a segment share an electrical connection. The display segment 500 is an electrical component and several display segments are typically assembled to create a display.

FIG. 6 is a plan view of a display segment 600 according to another embodiment of the invention. Three LED diodes 602, 604, 606 are mounted on a carrier (not shown in this view). A reflector 608 includes a perimeter reflective wall 609, and an intermediate reflector structure 610 that separates each LED dice from each other, and operates in conjunction the perimeter reflective wall 609 to surround each of the LEDs mounted on the carrier with reflective walls. The height of the intermediate reflector structure 610 is the same as the height of the perimeter reflective wall 609. Alternatively, the height of the intermediate reflector structure 610 is less than the perimeter reflective wall 609.

FIGS. 7A-7H are cross sections of embodiments of intermediate reflector structures. FIG. 7A shows an intermediate reflector structure 700 with straight walls 702, 704 that meet at an apex 706. The angle of the walls is selected by width of the base 708 according to the available space between LEDs in the cavity (see FIG. 4A). FIG. 7B shows an intermediate reflector structure 710 with straight walls 702′, 704′ and a truncated end 706′. An intermediate reflector structure in accordance with FIG. 7B was modeled to obtain the simulation results shown in FIG. 4B. FIG. 7C shows an intermediate reflector structure 720 with concave reflective sidewalls 722, 724 that meet at an apex 726. The concave reflective sidewalls are shaped as a portion of a circle, ellipse, parabola, or hyperbola, for example. In one embodiment, each sidewall is similarly curved. Alternatively, one sidewall is curved differently from the other, either by having a different radius, arc, or shape. In a particular embodiment, one sidewall is convex, and the other is concave.

FIG. 7D shows an intermediate reflector structure 720′ having concave reflective sidewalls 722′, 724′ that do not meet. The top 726′ of the intermediate reflector structure is truncated, similarly to FIG. 7B. FIGS. 7E and 7F show intermediate reflector structures 730, 730′ with convex reflective sidewalls 732, 734, 732′, 734′. FIG. 7G is an intermediate reflector structure 740 with a hemi-spherical reflective wall 742. FIG. 7H is an intermediate reflector structure 750 with a half-ellipsoid reflective wall 752.

Different shapes and cross-sections of intermediate reflector structures are used in different applications. For example, concave reflective walls, such as are shown in FIGS. 7C and 7D are desirable when high brightness of the segment, as viewed from the front, is desired. In a particular embodiment, the concave reflective walls are essentially parabolic. In other applications, such as when good brightness is desired over a wide viewing angle, a convex reflective wall may be more desirable.

While the preferred embodiments of the present invention have been illustrated in detail, it should be apparent that modifications and adaptations to these embodiments might occur to one skilled in the art without departing from the scope of the present invention as set forth in the following claims.

What is claimed is:

1. A display segment comprising:
a carrier;
a reflector structure having a cavity disposed on the carrier;
a first light-emitting diode attached to the carrier within the cavity;
a second light-emitting diode die attached to the carrier within the cavity; and
an intermediate reflector structure disposed on the carrier within the cavity between the first light-emitting diode and the second light-emitting diode having a first intermediate reflector wall proximate to the first light-emitting diode and a second intermediate reflector wall proximate to the second light-emitting diode.

2. The display segment of claim 1 further comprising a perimeter reflective wall circumscribing the cavity wherein the intermediate reflector structure cooperates with the perimeter reflective wall to surround the first light-emitting diode.

3. The display segment of claim 1 wherein the reflector structure includes a perimeter reflective wall having a first height from the carrier, wherein the intermediate reflector structure has a second height from the carrier, the first height being greater than the second height.

4. The display segment of claim 3 further comprising encapsulant essentially filling the cavity to cover the intermediate reflector structure.

5. The display of segment of claim 4 wherein the encapsulant includes dispersant.

6. The display segment of claim 1 wherein the first intermediate reflector wall and the second intermediate reflector wall are painted with white light reflecting paint.

7. The display segment of claim 1 wherein the first intermediate reflector wall and the second intermediate reflector wall are plated with a metal.

8. The display segment of claim 1 wherein the reflector structure and the intermediate reflector structure are integrated.

9. The display segment of claim 8 wherein the reflector structure and the intermediate reflector structure comprise injection molded plastic.

10. The display segment of claim 8 wherein the injection molded plastic is loaded with a reflective material.

11. The display segment of claim 1 wherein the reflector structure is a first component of the display segment and the intermediate reflector structure is a second component of the display segment, the first component and the second component each being disposed on the carrier.

12. The display segment of claim 11 wherein at least one of the reflector structure and the intermediate reflector structure includes a plastic loaded with a reflective material.

13. The display segment of claim 1 further comprising a third light-emitting diode attached to the carrier within the cavity, the intermediate reflector structure being disposed between the first light-emitting diode and third light-emitting diode, and between the second light-emitting diode and the third light-emitting diode.

14. The display segment of claim 1 wherein the first intermediate reflector wall is concave and the second intermediate reflector wall is concave.

15. The display segment of claim 14 wherein the first intermediate reflector wall is parabolic and the second intermediate reflector wall is parabolic.

16. The display segment of claim 1 wherein the first intermediate reflector wall is concave and the second intermediate reflector wall is convex.
